(19) United States
(12) Patent Application Publication
(10) Pub. No.: US 2010/0144196 A1
(43) Pub. Date: Jun. 10, 2010

(54) Board Mounted Connector System with Shield Assembly

(75) Inventors: YY LIU, Shenzhen (CN); HAORUN ZOU, Shenzhen (CN)

Correspondence Address: BAYSHORE PATENT GROUP, LLC, 520 CHANTECLER DR., FREMONT, CA, 94539, US

(73) Assignees: BizConn International Corp.(ShenZhen), ShenZhen (CN); BizLink Technology Inc., Fremont, CA (US)

(21) Appl. No.: 12/555,193

(22) Filed: Sep. 8, 2009

(30) Foreign Application Priority Data
Dec. 5, 2008 (CN) 200820214315.6

(51) Int. Cl. H01R 13/66; H01R 13/648

(52) U.S. Cl. 439/541.5; 439/607.01

(57) ABSTRACT

A connector assembly includes a connector body having a top surface with a predetermined width and a first and a second two side walls, the first two side walls having two grooves; and a metal shield assembly coupled to the top surface of the connector body comprising a base plate extending transversely, two bar members extending downwardly from the base plate engaged within the grooves of the first two side walls of the connector body and symmetrically arranged with a predetermined width approximately equal to the width of the top surface of the connector body, two tab members formed on the bar members being resiliently biased to engage the first side walls of the connector body, and at least one elastic leg member extending from the base plate in a tilted manner and bending toward one side to form the contact.

### CROSS-REFERENCE TO RELATED APPLICATIONS

This application claims the benefit of foreign application with application number 200820214315.6, filed Dec. 5, 2008, and entitled “Board Mounted Connector”, which is hereby incorporated herein by reference in its entirety.

### FILED OF THE INVENTION

The present invention relates to the board mounted connector. More specifically, the present invention relates to a board mounted connector having a shield assembly with elastic metal contacts for improving electrical connectivity and stability with the computer and reducing electrical interferences.

### BACKGROUND OF THE INVENTION

The conventional board mounted connector is electrically connected to the computer mother board. The connector is constituted by rectangle or square shaped housing box and a plurality of wire terminals disposed on the connector. As shown in FIG. 5, the connector 100 is mounted to the computer within a predetermined-sized socket. FIG. 5 shows a space or gap typically seen between the connector 100 and the socket of the computer panel 200. Since the connector 100 is not tightly connected to the computer panel 200, the space between the connector 100 and the socket may result in the loss of electrical connection or electromagnetic interferences. The conventional manufacturers use electric conductive foam 300 to cover the outside housing of the connector 100. As shown in FIG. 5, the connectors 100 is snuggled by the electric conductive foam 300. However, the electrical connectivity via the electric conductive foam 300 between the computer panel 200 and the connector 100 tends not stable and causes low product reliability problems. Moreover, the use of the electric conductive foam 300 can significantly increase the labor and cost and generate extra manufacture procedures. It can complicate the manufacturing process to the manufacturers.

It would be desirable to provide a board mounted connector that provides electrical connectivity and stability to connect with the computer panel. It would also be desirable to provide a board mounted connector that provides both simplified manufacturing process and reach quality assurance.

### SUMMARY

Disclosed herein is a board mounted connector assembly. In one embodiment, the connector assembly includes a connector body having a top surface with a predetermined width and a first and a second two side walls, the first two side walls having two grooves; and a metal shield assembly coupled to the top surface of the connector body comprising a base plate extending transversely, two bar members extending downwardly from the base plate engaged within the grooves of the first two side walls of the connector body and symmetrically arranged with a predetermined width approximately equal to the width of the top surface of the connector body, two tab members formed on the bar members being resiliently biased to engage the first side walls of the connector body, and at least one elastic leg member extending from the base plate in a tilted manner and bending toward one side to form the contact.

According to further embodiments of the present invention, A metal shield assembly for coupling to a connector body having a top surface with a predetermined width, and a first and a second two side walls, the first two side walls having two grooves, the assembly includes a base plate extending transversely; two bar members extending downwardly from the base plate engaged within the grooves of the first two side walls of the connector body and symmetrically arranged with a predetermined width approximately equal to the width of the top surface of the connector body; two tab members formed on the bar members being resiliently biased to engage the first two side walls of the connector body; and at least one elastic leg member extending from the base plate in a tilted manner and bending toward one side to form the contact.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a perspective view of the board mounted connector in accordance with the present invention;

FIG. 2 is a perspective view of the board mounted connector when the shield assembly is partially coupled with the connector body;

FIG. 3 is a perspective view of another embodiment of the board connector of the present invention when the shield assembly is completely coupled with the connector body;

FIG. 4 is a side, perspective view of the board connector of FIG. 3;

FIG. 5 is a perspective view showing an example of a conventional board wire in connection with the computer housing.

### DETAILED DESCRIPTION

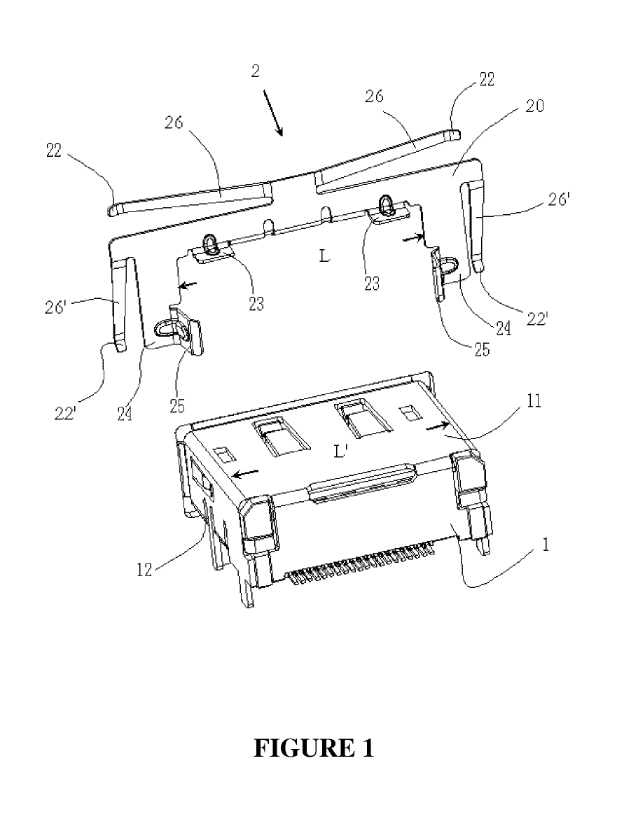

Disclosed herein is a board mounted connector 100 as shown in FIGS. 1-4. An embodiment of the board mounted connector 100 of the present invention includes, as shown in FIG. 1, a connector body 1, and a shield assembly 2.

As shown in FIG. 1, the connector body 1 includes a box-shaped housing 11 and a plurality of conductive terminals. In the present invention, the connector body 1 is a board mounted connector which can be connected to the computer mother board. In another embodiment, the connector body 1 can be a board connector connected to conventional electric devices. The shape of the housing 11 of the connector body 1 in the present invention can be a cube or a cuboid. In the present invention, the connector body 1 is a board mounted DIP type connector. Still in another embodiment, the connector body 1 is a board mounted SMP type connector. As shown in FIG. 1, the connector body 1 has a top surface with predetermined width (L′). The connector body 1 has a first two side walls and a second side walls.

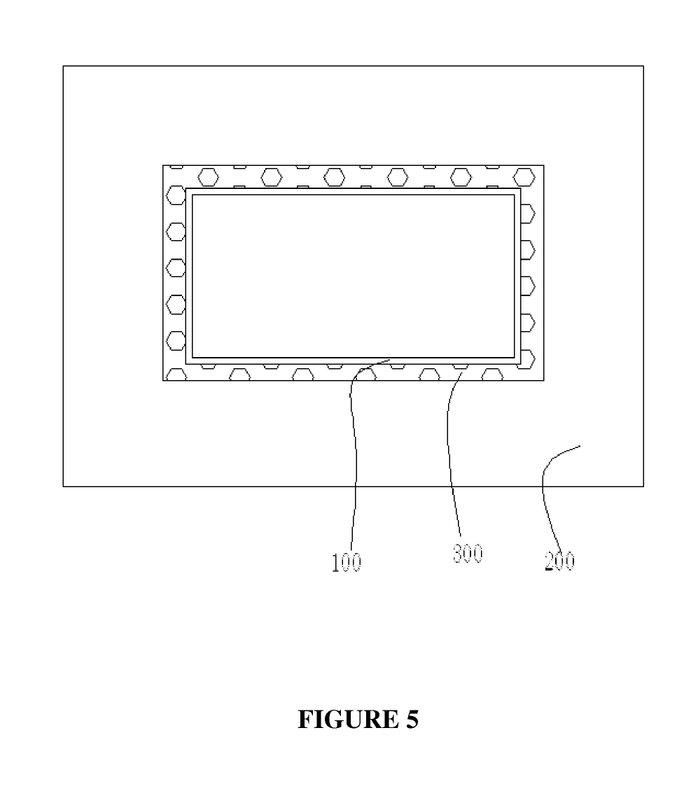

As shown in FIG. 1, the shield assembly 2 of the present invention has a base plate 20 extending transversely. Two stabilizing members 23 located near the middle of the base plate 20 are formed on the base plate 20. Two bar members 24 symmetrically arranged and extending downwardly from the base plate 20 are located near the medial and lateral side of the stabilizing members 23. The two bar members 24 are arranged in a predetermined length (L). The bottom portions of the bar members 24 include two tab members 25 which are formed on each of the corresponding bar member 24. The two tab members 25 are formed toward each other. The upper middle of the base plate 20 contains two elastic leg members 26 extending transversely and bending toward one side to form two contacts 22. The two elastic leg members are arranged in a tilted position along the transverse axis of the base plate 20. The very medial and lateral sides of the base plate 20 further contain two elastic leg members 26′ extending longitudely and bending toward one side to form two contacts 22′. The two elastic leg members 22′ are arranged in a tilted position along the longitude axis of the base plate 20. The leg members 26, 26′ and the corresponding contacts 22, 22′ extend outwardly from the shield assembly 2. In one embodiment of the present invention, the elastic leg members 26, 26′ can be extendable according to the manufacturers' needs. If the gap is obvious between the computer panel 200 and the board mounted connector 100 as shown in FIG. 5, the length of the elastic leg members 26, 26′ can be lengthened therefore the corresponding contacts 22, 22′ can touch with the computer panel 200. With this embodiment, the board mounted connector 100 can be electrically connected with the computer panel 200 via the engagement of the shield assembly 2 of the present invention. In another embodiment of the present invention, the shield assembly 2 contains at least one elastic leg member. Still in another embodiment, the shield assembly 2 contains two elastic leg members 26 extending transversely therefrom. Still in another embodiment, the shield assembly 2 contains two elastic leg members 26′ extending longitudely therefrom. Still in another embodiment of the present invention, the shield assembly 2 is made by conductive material such as metal. Still in another embodiment, the shield assembly 2 is made by metal injection molding.

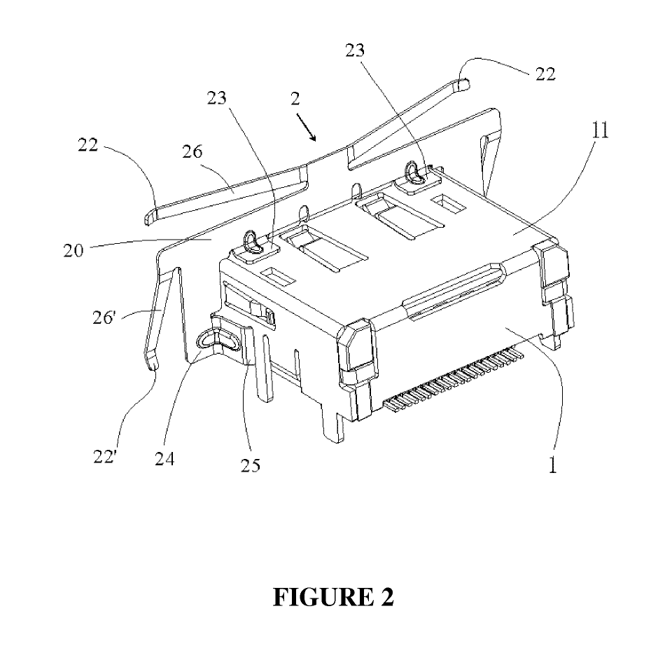

FIG. 2 shows the connector body 1 receives the shield assembly 2 in an engaged configuration. The bar members 24 are arranged in a predetermined width (L) according to the feature of the width (L′) of the connector body 1. In the present invention, the predetermined width (L) of the shield assembly 2 is approximately equal to the width (L′) of the top surface of the connector body 1. Still in another embodiment, the width (L) of the shield assembly 2 can be slightly larger than the width (L′) of the top surface of the connector body 1. The feature of the predetermined width (L) facilitates the insertion of the shield assembly 2 to be easily coupled with the connector body 1. As shown in FIG. 1, the connector body 1 includes the grooves 12 disposed on the two sidewalls thereof for facilitating the insertion of the shield assembly 2. The shield assembly 2 is coupled with the connector body 1 by inserting each of the two bar members 24 along the corresponding grooves 12 of the connector body 1. As shown in FIG. 2 in the engaged configuration, the stabilizing members 23 are attached to the top surface of the connector body 1. The features of the stabilizing members 23 provide a positioning function to stabilize the shield assembly 2 with the connector body 1 in an engaged configuration. Furthermore, as shown in FIG. 1, the two tabs 25 formed on each of the bar members 24 are formed toward each other in a general biased manner. When the shield assembly 2 is coupled with the connector body 1, the bias of the tab members 25 creates an elastic clamping pressure between two sides of the shield assembly 2 and the connector body 1. Such a clamping pressure is sufficient to hold and to prevent undesired removal of the shield assembly 2 from the connector body 1. Moreover, the clamping contact between the shield assembly 2 and the connector body 1 serves to create the electrically conductive connection passing the an electrical connection from the elastic leg members 26, 26′ and their corresponding contacts 22, 22′, respectively to the computer panel. Therefore with the shield assembly 2 of the present invention, the connector body 1 can be electrically connected with the computer panel without the interruption of the electrical connectivity and unwanted magnetic interferences.

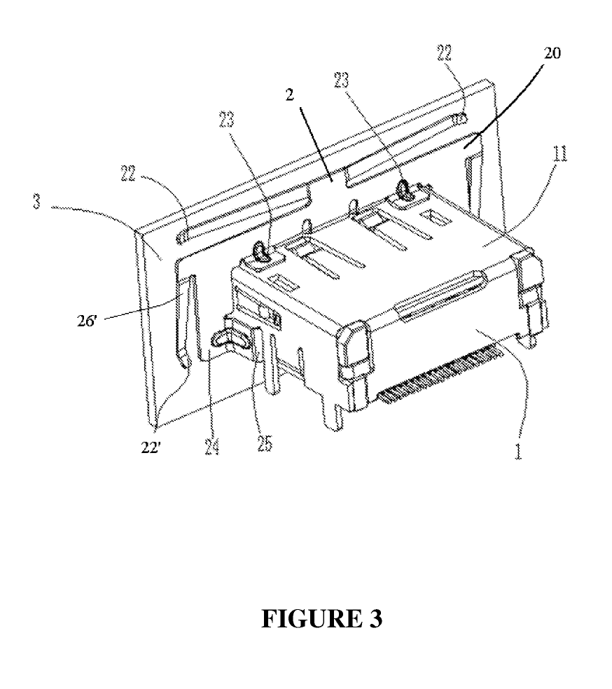

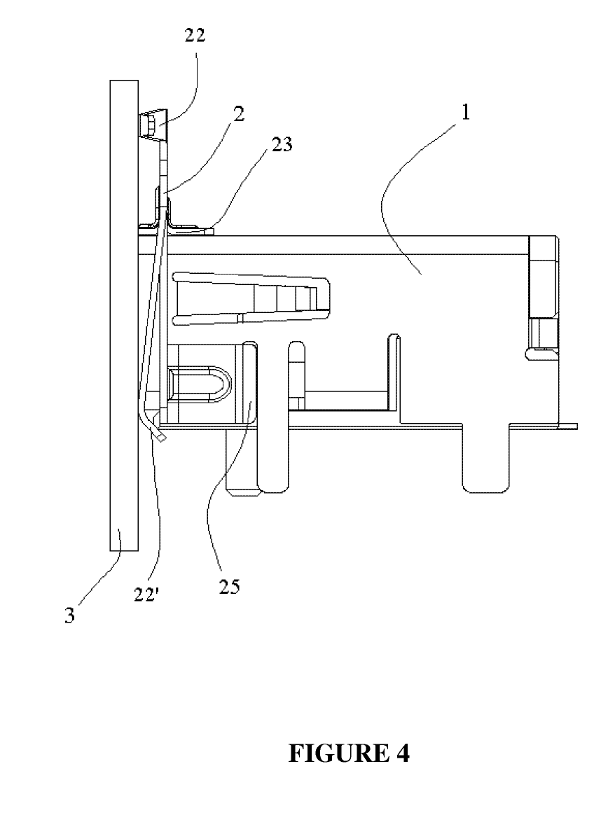

FIGS. 3-4 show another embodiment of the present invention when the shield assembly 2 is completely coupled with the connector body 1. With this embodiment, the shield assembly 2 is mounted to a flat plate 3. The feature of the flat plate 3 facilitates the positioning and engagement of the shield assembly 2 with the connector body 1. In another embodiment of the present invention, the shield assembly 2 is plate-shaped which is made of conductive material, such as metal. As shown in FIG. 3, the shield assembly 2 contains two elastic leg members 26 extending transversely in a tilted manner outward from the flat plate 3 and bending toward one side to form two corresponding contacts 22. The shield assembly 2 contains the other two elastic leg members 26′ extending longitudely in a tilted manner outward from the flat plate 3 and bending toward one side to form two corresponding contacts 22′. In one embodiment of the present invention, the elastic leg members 26, 26′ can be extendable according to the manufacturers′ needs. In another embodiment of the present invention, the shield assembly 2 contains at least one elastic leg member. Still in another embodiment, the shield assembly 2 contains two elastic leg members 26 extending transversely therefrom. Still in another embodiment, the shield assembly 2 contains two elastic leg members 26′ extending longitudely therefrom. As shown in FIGS. 3-4, the elastic leg members 26, 26′ and the corresponding contacts 22, 22′ extend outwardly from the base plate 2 of the shield assembly 2. The length of the leg members 26, 26′ can be extendable according to the manufacturers′ needs. If the gap is obvious between the computer panel 200 and the board mounted connector 100 as shown in FIG. 5, the length of the elastic leg members 26, 26′ can be lengthened therefore the corresponding contacts 22, 22′ can touch with the computer panel 200. With this embodiment, the board mounted connector 100 can be electrically connected with the computer panel 200 via the engagement of the shield assembly 2 of the present invention. Still in another embodiment of the present invention, the shield assembly 2 is made by conductive material such as metal. Still in another embodiment, the shield assembly 2 is made by metal injection molding.

Although the present invention has been described with reference to preferred embodiment, persons skilled in the art will recognize that changes may be made in form and detail without departing from the spirit and scope of the invention.

What is claimed is:

1. A board mounted connector assembly comprising:
a connector body having a top surface with a predetermined width and a first and a second two side walls, said first two side walls having two grooves; and
a metal shield assembly coupled to said top surface of said connector body comprising a base plate extending transversely, two bar members extending downwardly from said base plate engaged within said grooves of said first two side walls of said connector body and symmetrically arranged with a predetermined width approximately equal to said width of said top surface of said connector body, two tab members formed on said bar members being resiliently biased to engage said first side walls of said connector body, and at least one elastic leg member extending from said base plate in a tilted manner and bending toward one side to form the contact.

2. The connector assembly of claim 1, wherein said base member of said shield assembly contains one pair of stabilizing members.

3. The connector assembly of claim 2, wherein said shield assembly comprises a pair of elastic leg members extending transversely in a tilted manner being toward one side to form a pair of said contacts.

4. The connector assembly of claim 2, wherein said shield assembly comprises a pair of elastic leg members extending downwardly in a tilted manner being toward one side to form a pair of said contacts.

5. The connector assembly of claim 3, wherein said shield assembly comprises a pair of elastic leg members extending downwardly in a tilted manner being toward one side to form a pair of said contacts.

6. The connector assembly of claim 2, wherein said shield assembly is mounted to a metal plate or is metal plate-shaped.

7. The connector assembly of claim 3, wherein said shield assembly is mounted to metal plate or is metal plate-shaped.

8. The connector assembly of claim 4, wherein said shield assembly is mounted to a metal plate or is metal plate-shaped.

9. The connector assembly of claim 5, wherein said shield assembly is mounted to a metal plate or is metal plate-shaped.

10. A metal shield assembly for coupling to a connector body having a top surface with a predetermined width, and a first and a second two side walls, said first two side walls having two grooves, the assembly comprising:
a base plate extending transversely;
two bar members extending downwardly from said base plate engaged within said grooves of said first two side walls of said connector body and symmetrically arranged with a predetermined width approximately equal to said width of said top surface of said connector body;
two tab members formed on said bar members being resiliently biased to engage said first two side walls of said connector body; and
at least one elastic leg member extending from said base plate in a tilted manner and bending toward one side to form the contact.

11. The shield assembly of claim 10, wherein said base member of said shield assembly contains one pair of stabilizing members.

12. The connector assembly of claim 11, wherein said shield assembly comprises a pair of elastic leg members extending transversely in a tilted manner being toward one side to form a pair of said contacts.

13. The connector assembly of claim 11, wherein said shield assembly comprises a pair of elastic leg members extending downwardly in a tilted manner being toward one side to form a pair of said contacts.

14. The connector assembly of claim 12, wherein said shield assembly comprises a pair of elastic leg members extending downwardly in a tilted manner being toward one side to form a pair of said contacts.

15. The connector assembly of claim 11, wherein said shield assembly is mounted to a metal plate or is metal plate-shaped.

16. The connector assembly of claim 12, wherein said shield assembly is mounted to a metal plate or is metal plate-shaped.

17. The connector assembly of claim 13, wherein said shield assembly is mounted to a metal plate or is metal plate-shaped.

18. The connector assembly of claim 14, wherein said shield assembly is mounted to a metal plate or is metal plate-shaped.
